(19) United States
(12) Patent Application Publication
(10) Pub. No.: US 2024/0326818 A1
(43) Pub. Date: Oct. 3, 2024

(54) LANE CHANGE ASSISTANCE DEVICE AND LANE CHANGE ASSISTANCE METHOD

(71) Applicant: Panasonic Automotive Systems Co., Ltd., Kanagawa (JP)

(72) Inventors: Yuusuke SHIOZAKI, Tokyo (JP); Kohei ASHIDA, Tokyo (JP); Satoshi KAWAMURA, Kanagawa (JP); Rumi OHNISHI, Osaka (JP)

(73) Assignee: Panasonic Automotive Systems Co., Ltd., Kanagawa (JP)

(21) Appl. No.: 18/606,221

(22) Filed: Mar. 15, 2024

(30) Foreign Application Priority Data
Mar. 28, 2023 (JP) 2023-051374

(51) Int. Cl. B60W 30/18; B60W 50/14

(52) U.S. Cl. CPC B60W 30/18163; B60W 2050/146

(57) ABSTRACT

A lane change assistance device includes: a lane change need determiner that determines whether there is a situation that requires a vehicle to make a lane change to an adjacent lane, based on surrounding environment information; a lane changeability determiner that determines whether it is possible for the vehicle to make the lane change, by detecting any other vehicle traveling in the adjacent lane based on the surrounding environment information; and a display controller that causes, when the lane change need determiner determines that there is the situation that requires the vehicle to make the lane change, a display to display a highlighted image indicating whether it is possible for the vehicle to make the lane change in a state in which the image is superimposed on the adjacent lane when seen through a windshield of the vehicle, based on a determination result of the lane changeability determiner.

### CROSS REFERENCE TO RELATED APPLICATION

The present application is based on and claims priority of Japanese Patent Application No. 2023-051374 filed on Mar. 28, 2023.

### FIELD

The present disclosure relates to a lane change assistance device and a lane change assistance method.

### BACKGROUND

Lane change assistance devices are known that assist a vehicle to make a lane change to an adjacent lane (see, for example, Patent Literature (PTL) 1). A conventional lane change assistance device includes: a camera that captures an image of the rear and sides of a vehicle; a display that displays the rear and side image captured by the camera; a determiner that determines, based on the result of imaging by the camera, the degree of risk associated with the vehicle making a lane change to an adjacent lane; and a controller that superimposes a highlighted image indicating the determined degree of risk on the rear and side image displayed on the display. The display is located on the instrument panel in front of the driver's seat of the vehicle.

### CITATION LIST

### Patent Literature

PTL 1: Japanese Patent No. 6142784

### SUMMARY

However, the conventional lane change assistance device described above can be improved upon.

In view of this, the present disclosure provides a lane change assistance device and lane change assistance method capable of improving upon the above related art.

A lane change assistance device according to one aspect of the present disclosure is a lane change assistance device that assists a vehicle to make a lane change to an adjacent lane, the lane change assistance device including: a lane change need determiner that determines whether there is a situation that requires the vehicle to make the lane change to the adjacent lane, based on surrounding environment information indicating a surrounding environment of the vehicle or operation information indicating that a direction indicator of the vehicle has been operated by a driver; a lane changeability determiner that determines whether it is possible for the vehicle to make the lane change to the adjacent lane, by detecting any other vehicle traveling in the adjacent lane based on the surrounding environment information; and a display controller that causes, when the lane change need determiner determines that there is the situation that requires the vehicle to make the lane change to the adjacent lane, a display to display an image indicating whether it is possible for the vehicle to make the lane change to the adjacent lane in a state in which the image is superimposed on the adjacent lane when seen through a display medium of the vehicle, based on a determination result of the lane changeability determiner.

These general and specific aspects may be implemented using a system, a method, an integrated circuit, a computer program, or a computer-readable non-transitory recording medium such as compact disc-read only memory (CD-ROM), or any combination of systems, methods, integrated circuits, computer programs, and recording media.

A lane change assistance device, etc. according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a vehicle on which a display system according to an embodiment is mounted.

FIG. 2 is a diagram illustrating the area of the windshield where a HUD image is displayed by the display system according to the embodiment.

FIG. 3 is a schematic diagram illustrating the structure of the display system according to the embodiment.

FIG. 4 is a diagram illustrating an example of a situation in which the vehicle makes a lane change to an adjacent lane.

FIG. 5 is a block diagram illustrating the functional structure of a lane change assistance device according to the embodiment.

FIG. 6 is a diagram illustrating an example of highlighted images in the display system according to the embodiment.

FIG. 7 is a flowchart illustrating the flow of operation of the lane change assistance device according to the embodiment.

FIG. 8 is a diagram illustrating an example of a highlighted image in a display system according to a variation of the embodiment.

### DESCRIPTION OF EMBODIMENT

### (Underlying Knowledge Forming Basis of the Present Disclosure)

The present inventors have found the following problem with the technology described in the “Background” section.

The conventional lane change assistance device described above has a problem in that it is difficult for the driver to intuitively determine whether a lane change is possible.

In order to solve such a problem, a lane change assistance device according to a first aspect of the present disclosure is a lane change assistance device that assists a vehicle to make a lane change to an adjacent lane, the lane change assistance device including: a lane change need determiner that determines whether there is a situation that requires the vehicle to make the lane change to the adjacent lane, based on surrounding environment information indicating a surrounding environment of the vehicle or operation information indicating that a direction indicator of the vehicle has been operated by a driver; a lane changeability determiner that determines whether it is possible for the vehicle to make the lane change to the adjacent lane, by detecting any other vehicle traveling in the adjacent lane based on the surrounding environment information; and a display controller that causes, when the lane change need determiner determines that there is the situation that requires the vehicle to make the lane change to the adjacent lane, a display to display an image indicating whether it is possible for the vehicle to make the lane change to the adjacent lane in a state in which the image is superimposed on the adjacent lane when seen through a display medium of the vehicle, based on a determination result of the lane changeability determiner.

When the driver attempts to make a lane change to the adjacent lane, the driver's eyes naturally move to the adjacent lane seen through the display medium of the vehicle. According to this aspect, the image indicating whether the vehicle can make a lane change to the adjacent lane is displayed in a state of being superimposed on the adjacent lane when seen through the display medium of the vehicle, and as a result the driver naturally views the image. Consequently, the driver can intuitively determine whether the lane change is possible.

For example, in a second aspect, in the lane change assistance device according to the first aspect, the lane changeability determiner may calculate a degree of margin for the vehicle to make the lane change to the adjacent lane and, based on the degree of margin, determine, in levels, whether it is possible for the vehicle to make the lane change to the adjacent lane.

According to this aspect, the driver can determine whether the lane change is possible in levels.

For example, in a third aspect, in the lane change assistance device according to the second aspect, the display controller may vary a display mode of the image depending on the degree of margin.

According to this aspect, the driver can determine whether the lane change is possible in levels depending on the display mode of the image.

For example, in a fourth aspect, in the lane change assistance device according to any one of the first aspect to the third aspect, the display may project light representing the image to the display medium and cause the light to reflect off the display medium, to display the image as a virtual image through the display medium.

According to this aspect, the image can be displayed in a state of being superimposed on the adjacent lane when seen through the display medium of the vehicle, using head-up display technology.

For example, in a fifth aspect, in the lane change assistance device according to the fourth aspect, the display medium may be at least one of a windshield or a door glass of the vehicle.

According to this aspect, the image can be displayed in a state of being superimposed on the adjacent lane when seen through at least one of the windshield or door glass of the vehicle.

A lane change assistance method according to a sixth aspect of the present disclosure is a lane change assistance method of assisting a vehicle to make a lane change to an adjacent lane, the lane change assistance method including: (a) determining whether there is a situation that requires the vehicle to make the lane change to the adjacent lane, based on surrounding environment information indicating a surrounding environment of the vehicle or operation information indicating that a direction indicator of the vehicle has been operated by a driver; (b) determining whether it is possible for the vehicle to make the lane change to the adjacent lane, by detecting any other vehicle traveling in the adjacent lane based on the surrounding environment information; and (c) causing, when it is determined in (a) that there is the situation that requires the vehicle to make the lane change to the adjacent lane, a display to display an image indicating whether it is possible for the vehicle to make the lane change to the adjacent lane in a state in which the image is superimposed on the adjacent lane when seen through a display medium of the vehicle, based on a determination result of (b).

According to this aspect, the driver can intuitively determine whether the lane change is possible, as mentioned above.

An embodiment will be described in detail below, with reference to the drawings.

The embodiment described below shows a general or specific example. The numerical values, shapes, materials, structural elements, the arrangement and connection of the structural elements, steps, the processing order of the steps etc. shown in the following embodiment are mere examples, and do not limit the scope of the present disclosure. Of the structural elements in the embodiment described below, the structural elements not recited in any one of the independent claims representing the broadest concepts are described as optional structural elements.

### EMBODIMENT

### [1. Overview of Display System]

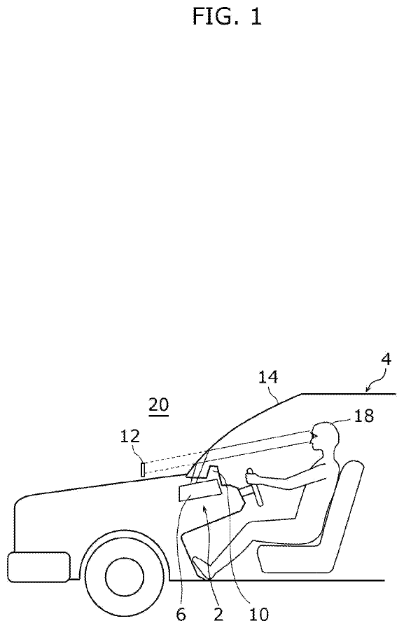

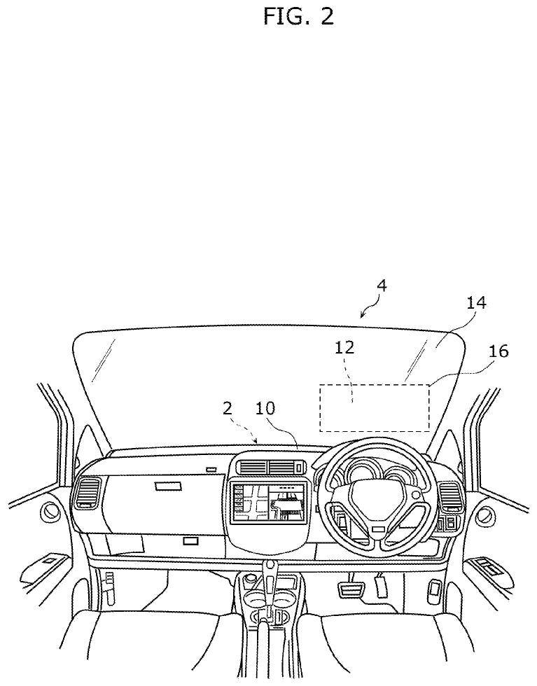

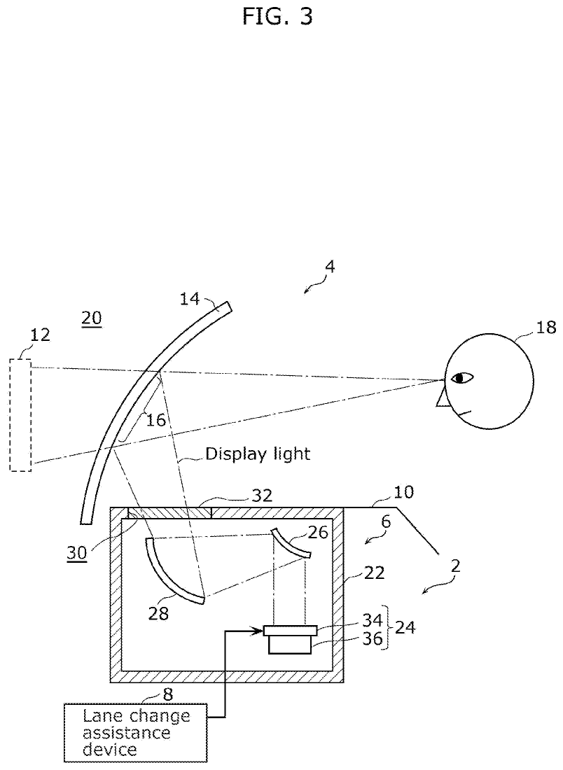

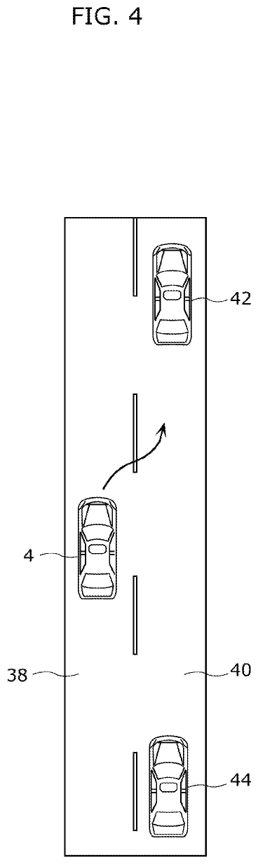

First, an overview of display system 2 according to an embodiment will be described with reference to FIGS. 1 to 4. FIG. 1 is a diagram illustrating vehicle 4 on which display system 2 according to the embodiment is mounted. FIG. 2 is a diagram illustrating area 16 of windshield 14 where HUD image 12 is displayed by display system 2 according to the embodiment. FIG. 3 is a schematic diagram illustrating the structure of display system 2 according to the embodiment. FIG. 4 is a diagram illustrating an example of a situation in which vehicle 4 makes a lane change to adjacent lane 40.

As illustrated in FIGS. 1 and 2, display system 2 according to the embodiment is mounted on vehicle 4 such as an automobile. As illustrated in FIG. 3, display system 2 includes display 6 and lane change assistance device 8.

Display 6 is, for example, a head-up display (HUD), and is located inside dashboard 10 of vehicle 4. As illustrated in FIGS. 1 to 3, display 6 projects display light for displaying HUD image 12 which is a virtual image to, for example, area 16 closer to the driver's seat in windshield 14 (an example of a display medium) of vehicle 4, to cause the display light to reflect off area 16 of windshield 14 toward driver 18. This enables driver 18 to see HUD image 12 as a virtual image in a state of being superimposed on the view ahead of windshield 14 through area 16 of windshield 14. That is, HUD image 12 appears to driver 18 as if it were displayed in space 20 in front of windshield 14. In FIG. 2, HUD image 12 is not illustrated for explanatory convenience.

As illustrated in FIG. 3, display 6 includes main housing 22, display unit 24, first mirror 26, and second mirror 28.

Main housing 22 is box-shaped, and is made of metal such as aluminum, for example. Main housing 22 is located inside dashboard 10 of vehicle 4. Display unit 24, first mirror 26, and second mirror 28 are arranged inside main housing 22. The upper surface of main housing 22 faces windshield 14. Opening 30 is formed in the upper surface of main housing 22. Opening 30 is covered with plate-shaped cover member 32 made of, for example, transparent resin.

Display unit 24 is a picture generation unit (PGU) that projects display light for displaying HUD image 12 to first mirror 26 and second mirror 28. Display unit 24 includes display panel 34 and backlight 36. Display panel 34 is, for example, a liquid crystal display (LCD), and displays an image that is the source of HUD image 12 on the front display surface. Backlight 36 emits light toward the back surface of display panel 34.

First mirror 26 is, for example, a convex mirror, and reflects the display light from display unit 24 toward second mirror 28. Second mirror 28 is, for example, a concave mirror, and reflects the display light from first mirror 26 toward area 16 of windshield 14. The display light from second mirror 28 is transmitted through cover member 32 and reflected off area 16 of windshield 14, and then enters the eyes of driver 18.

Lane change assistance device 8 is a device that assists vehicle 4 traveling in travel lane 38 to make a lane change to adjacent lane 40 adjacent to travel lane 38 on one side (for example, the right side of driver 18), as illustrated in FIG. 4. For example, in adjacent lane 40, another vehicle 42 is traveling on the right front side of vehicle 4, and another vehicle 44 is traveling on the right rear side of vehicle 4. The functional structure of lane change assistance device 8 will be described below.

### [2. Functional Structure of Lane Change Assistance Device]

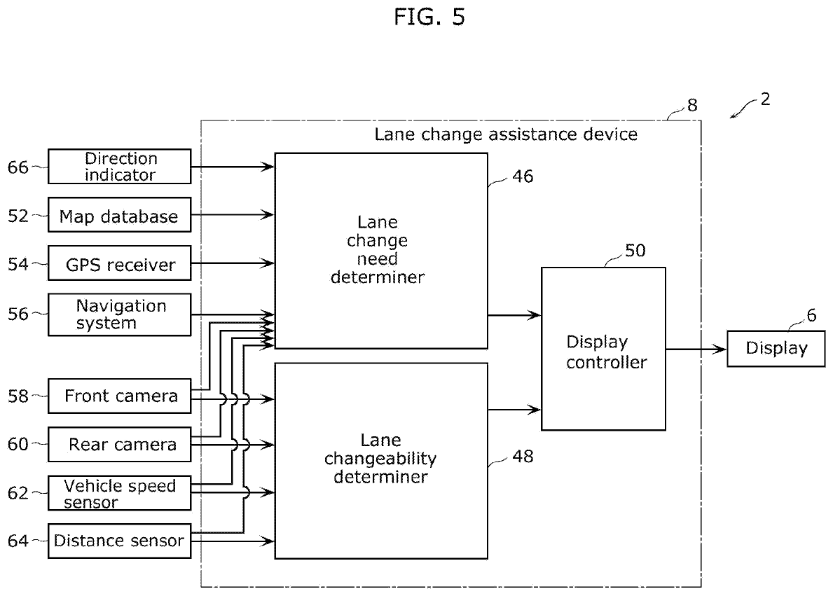

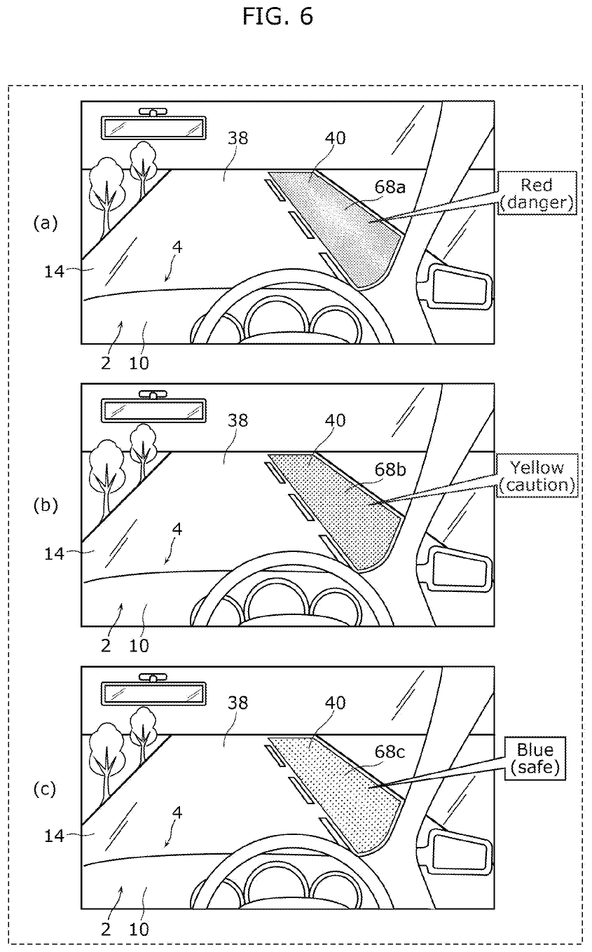

The functional structure of lane change assistance device 8 according to the embodiment will be described with reference to FIGS. 5 and 6. FIG. 5 is a block diagram illustrating the functional structure of lane change assistance device 8 according to the embodiment. FIG. 6 is a diagram illustrating an example of highlighted images 68a, 68b, and 68c in display system 2 according to the embodiment.

As illustrated in FIG. 5, lane change assistance device 8 includes lane change need determiner 46, lane changeability determiner 48, and display controller 50 as functional components.

Lane change need determiner 46 determines whether there is a situation that requires vehicle 4 to make a lane change to adjacent lane 40 (see FIG. 4), based on surrounding environment information indicating the surrounding environment of vehicle 4.

For example, lane change need determiner 46 obtains, as the surrounding environment information, (a) map information from map database 52 mounted on vehicle 4, (b) current position information indicating the current position of vehicle 4 from Global Positioning System (GPS) receiver 54 mounted on vehicle 4, (c) route information indicating the scheduled travel route of vehicle 4 and Vehicle Information and Communication System (VICS (registered trademark)) information from navigation system 56 mounted on vehicle 4, (d) front image information indicating an image in front of vehicle 4 captured by front camera 58 mounted on vehicle 4, (e) rear image information indicating an image behind vehicle 4 captured by rear camera 60 mounted on vehicle 4, (f) vehicle speed information indicating the vehicle speed of vehicle 4 detected by vehicle speed sensor 62 mounted on vehicle 4, (g) distance information indicating the distance between vehicle 4 and each of other vehicles 42, 44, etc. detected by distance sensor 64 such as laser imaging detection and ranging (LiDAR), sonar, or radar mounted on vehicle 4, and the like. The map information includes information indicating lane reductions, right-turn-only lanes, left-turn-only lanes, etc. on the route on which vehicle 4 is traveling.

Examples of the “situation that requires vehicle 4 to make a lane change to adjacent lane 40” include (a) a case where travel lane 38 (see FIG. 4) of vehicle 4 disappears as a result of a decrease in the number of lanes ahead (hereafter referred to as “case 1”), (b) a case where travel lane 38 of vehicle 4 is restricted due to construction etc. ahead (hereafter referred to as “case 2”), (c) a case where vehicle 4 is traveling in a right-turn-only lane (or left-turn-only lane) while driver 18 has no intention of turning right (or turning left) (hereafter referred to as “case 3”), (d) a case where another vehicle (not illustrated) is parked on a side strip ahead of vehicle 4 and there is no space for vehicle 4 to travel in the lane in which vehicle 4 is currently traveling (hereafter referred to as “case 4”), and (e) a case where an emergency vehicle such as an ambulance is traveling in travel lane 38 of vehicle 4 and is approaching vehicle 4 from behind (hereafter referred to as “case 5”).

In cases 1 and 2, lane change need determiner 46 determines whether there is a situation that requires vehicle 4 to make a lane change to adjacent lane 40 based on surrounding environment information obtained from various databases, such as route information and VICS (registered trademark) information. In cases 4 and 5, lane change need determiner 46 determines whether there is a situation that requires vehicle 4 to make a lane change to adjacent lane 40 based on surrounding environment information obtained in real time from various sensors, such as distance information. In case 3, lane change need determiner 46 determines whether there is a situation that requires vehicle 4 to make a lane change to adjacent lane 40 based on surrounding environment information obtained from various databases and surrounding environment information obtained from various sensors in real time.

Examples of the foregoing “case where vehicle 4 is traveling in a right-turn-only lane (or left-turn-only lane) while driver 18 has no intention of turning right (or turning left)” include an instance in which vehicle 4 is traveling in a right-turn-only lane (or left-turn-only lane) while navigation system 56 guides vehicle 4 to go straight through an intersection. Lane change need determiner 46 determines whether driver 18 has an intention of turning right (or turning left) based on, for example, an image of driver 18 captured by an in-vehicle camera (not illustrated) of vehicle 4, route information from navigation system 56, etc.

In addition to (or instead of) the foregoing information as surrounding environment information, lane change need determiner 46 may obtain operation information indicating that direction indicator 66 of vehicle 4 has been operated by driver 18. In this case, lane change need determiner 46 may determine whether there is a situation that requires vehicle 4 to make a lane change to adjacent lane 40 according to the intention of driver 18, based on the operation information from direction indicator 66.

Lane changeability determiner 48 determines whether it is possible for vehicle 4 to make a lane change to adjacent lane 40, by detecting other vehicles 42, 44, etc. traveling in adjacent lane 40 based on surrounding environment information.

Lane changeability determiner 48 obtains, as the surrounding environment information, (a) front image information indicating an image in front of vehicle 4 captured by front camera 58 mounted on vehicle 4, (b) rear image information indicating an image behind vehicle 4 captured by rear camera 60 mounted on vehicle 4, (c) vehicle speed information indicating the vehicle speed of vehicle 4 detected by vehicle speed sensor 62 mounted on vehicle 4, (d) distance information indicating the distance between vehicle 4 and each of other vehicles 42, 44, etc. detected by distance sensor 64 mounted on vehicle 4, and the like.

More specifically, lane changeability determiner 48 calculates the degree of margin for vehicle 4 to make a lane change to adjacent lane 40 based on the surrounding environment information and, based on the degree of margin, determines, in levels, whether it is possible for vehicle 4 to make a lane change to adjacent lane 40. For example, the degree of margin is expressed as a numerical value in three levels “1”, “2”, and “3”. A larger numerical value indicates a higher degree of margin for vehicle 4 to make a lane change to adjacent lane 40. In detail, the degree of margin “1” indicates that the lane change is dangerous, the degree of margin “2” indicates that the lane change requires caution, and the degree of margin “3” indicates that the lane change is safe.

For example, in the case where the distance between vehicle 4 and any of other vehicles 42, 44, etc. traveling in adjacent lane 40 is less than a predetermined distance and thus there is not a sufficient space for the lane change of vehicle 4 in adjacent lane 40, lane changeability determiner 48 determines that it is impossible for vehicle 4 to make a lane change to adjacent lane 40 and calculates the degree of margin “1”.

For example, in the case where the distance between vehicle 4 and each of other vehicles 42, 44, etc. traveling in adjacent lane 40 is not less than the predetermined distance but still there is not a sufficient space for the lane change of vehicle 4 in adjacent lane 40, lane changeability determiner 48 determines that it is possible for vehicle 4 to make a lane change to adjacent lane 40 with sufficient caution and calculates the degree of margin “2”.

For example, in the case where the distance between vehicle 4 and each of other vehicles 42, 44, etc. traveling in adjacent lane 40 is much longer than the predetermined distance and thus there is a sufficient space for the lane change of vehicle 4 in adjacent lane 40, lane changeability determiner 48 determines that it is possible for vehicle 4 to make a lane change to adjacent lane 40 and calculates the degree of margin “3”.

Display controller 50 controls the display of highlighted images 68a, 68b, and 68c (an example of an image) that are each HUD image 12 displayed on display panel 34 of display 6. Specifically, in the case where lane change need determiner 46 determines that there is a situation that requires vehicle 4 to make a lane change to adjacent lane 40, display controller 50 causes display panel 34 of display 6, etc. to display any of highlighted images 68a, 68b, and 68c in a state of being superimposed on adjacent lane 40 when seen through windshield 14 of vehicle 4 based on the determination result of lane changeability determiner 48, as illustrated in (a) to (c) in FIG. 6. Each of highlighted images 68a, 68b, and 68c is an image indicating whether it is possible for vehicle 4 to make a lane change to adjacent lane 40.

Here, display controller 50 displays highlighted images 68a, 68b, and 68c in different colors (an example of a display mode) depending on the degree of margin calculated by lane changeability determiner 48. Specifically, in the case where lane changeability determiner 48 calculates the degree of margin “1”, display controller 50 sets the color of highlighted image 68a to “red” indicating that the lane change is dangerous, as illustrated in (a) in FIG. 6. In the case where lane changeability determiner 48 calculates the degree of margin “2”, display controller 50 sets the color of highlighted image 68b to “yellow” indicating that the lane change requires caution, as illustrated in (b) in FIG. 6. In the case where lane changeability determiner 48 calculates the degree of margin “3”, display controller 50 sets the color of highlighted image 68c to “blue” indicating that the lane change is safe, as illustrated in (c) in FIG. 6.

Although display controller 50 displays highlighted images 68a, 68b, and 68c in different colors depending on the degree of margin in this embodiment, the present disclosure is not limited to such. For example, display controller 50 may display highlighted images 68a, 68b, and 68c in different color densities, patterns, luminance levels, etc. (each of which is an example of a display mode) depending on the degree of margin.

### [3. Operation of Lane Change Assistance Device]

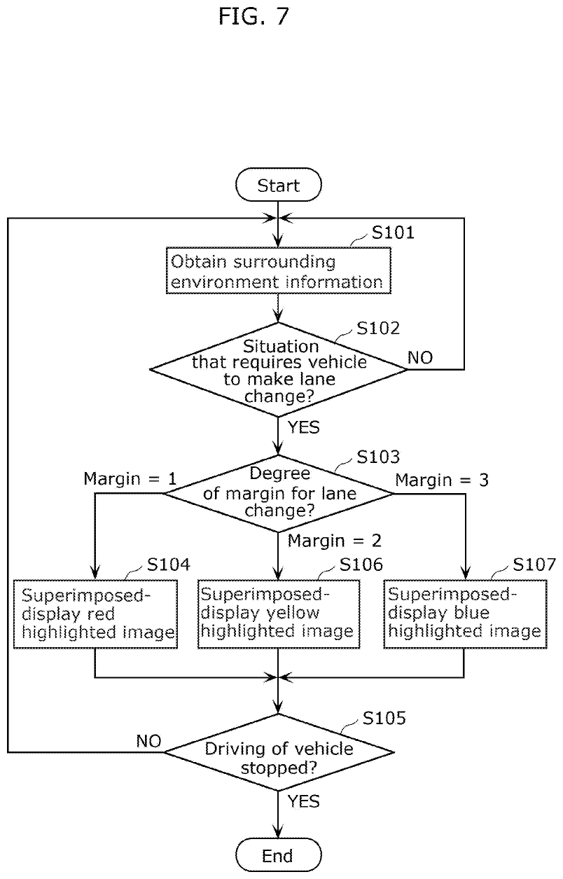

Next, the operation of lane change assistance device 8 according to the embodiment will be described with reference to FIGS. 6 and 7. FIG. 7 is a flowchart illustrating the flow of operation of lane change assistance device 8 according to the embodiment.

As illustrated in FIG. 7, each of lane change need determiner 46 and lane changeability determiner 48 obtains surrounding environment information (S101). Lane change need determiner 46 then determines whether there is a situation that requires vehicle 4 to make a lane change to adjacent lane 40, based on the surrounding environment information. In the case where there is not a situation that requires vehicle 4 to make a lane change to adjacent lane 40 (S102: NO), the process returns to Step S101.

In the case where there is a situation that requires vehicle 4 to make a lane change to adjacent lane 40 (S102: YES), lane changeability determiner 48 calculates the degree of margin based on the surrounding environment information and, based on the degree of margin, determines, in levels, whether it is possible for vehicle 4 to make a lane change to adjacent lane 40.

In the case where lane changeability determiner 48 calculates the degree of margin “1” (S103: “margin=1”), display controller 50 causes display 6 to display red highlighted image 68a in a state of being superimposed on adjacent lane 40 when seen through windshield 14 of vehicle 4 as illustrated in (a) in FIG. 6 (S104). Here, display controller 50 may cause display 6 to display not only red highlighted image 68a in a state of being superimposed on adjacent lane 40 but also an image indicating, for example, the word “danger” in a state of being superimposed on adjacent lane 40 when seen through windshield 14 of vehicle 4. After this, in the case where driver 18 continues driving vehicle 4 (S105: NO), the process returns to Step S101. In the case where driver 18 stops driving vehicle 4 (S105: YES), the process in the flowchart of FIG. 7 ends.

In the case where lane changeability determiner 48 calculates the degree of margin “2” in Step S103 (S103: “margin=2”), display controller 50 causes display 6 to display yellow highlighted image 68b in a state of being superimposed on adjacent lane 40 when seen through windshield 14 of vehicle 4 as illustrated in (b) in FIG. 6 (S106). Here, display controller 50 may cause display 6 to display not only yellow highlighted image 68b in a state of being superimposed on adjacent lane 40 but also an image indicating, for example, the word “caution” in a state of being superimposed on adjacent lane 40 when seen through windshield 14 of vehicle 4. The process then advances to Step S105.

In the case where lane changeability determiner 48 calculates the degree of margin “3” in Step S103 (S103: “margin=3”), display controller 50 causes display 6 to display blue highlighted image 68c in a state of being superimposed on adjacent lane 40 when seen through windshield 14 of vehicle 4 as illustrated in (c) in FIG. 6 (S107). Here, display controller 50 may cause display 6 to display not only blue highlighted image 68c in a state of being superimposed on adjacent lane 40 but also an image indicating, for example, the word “safe” in a state of being superimposed on adjacent lane 40 when seen through windshield 14 of vehicle 4. The process then advances to Step S105.

### [4. Effects]

When driver 18 attempts to make a lane change to adjacent lane 40, his or her eyes naturally move to adjacent lane 40 seen through windshield 14 of vehicle 4. Thus, as a result of any of highlighted images 68a, 68b, and 68c being displayed in a state of being superimposed on adjacent lane 40 when seen through windshield 14 of vehicle 4, driver 18 naturally views the highlighted image.

For example, when attempting to make a lane change to adjacent lane 40, driver 18 can intuitively recognize that the lane change is dangerous by viewing red highlighted image 68a displayed in the direction to which his or her eyes naturally move. For example, when attempting to make a lane change to adjacent lane 40, driver 18 can intuitively recognize that the lane change requires caution by viewing yellow highlighted image 68b displayed in the direction to which his or her eyes naturally move. For example, when attempting to make a lane change to adjacent lane 40, driver 18 can intuitively recognize that the lane change is safe by viewing blue highlighted image 68c displayed in the direction to which his or her eyes naturally move.

Hence, by naturally viewing any of highlighted images 68a, 68b, and 68c, driver 18 can intuitively determine whether the lane change is possible.

### [5. Variation]

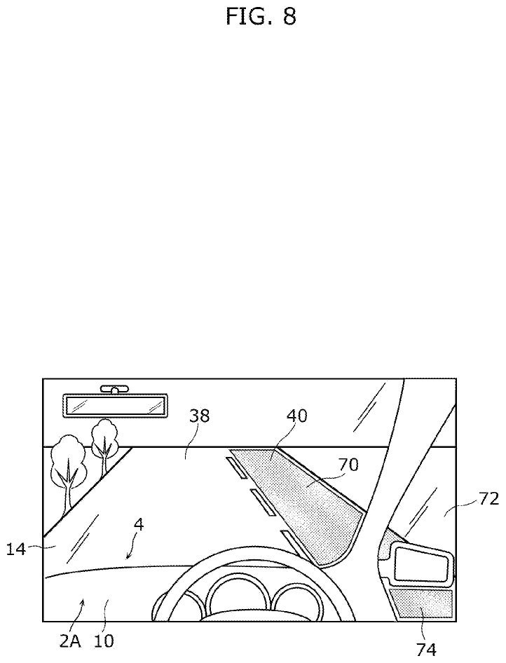

FIG. 8 is a diagram illustrating an example of highlighted images 70 and 74 in display system 2A according to a variation of the embodiment.

In display system 2A according to the variation, highlighted image 70 is displayed in a state of being superimposed on adjacent lane 40 when seen through windshield 14 of vehicle 4, and also highlighted image 74 is displayed in a state of being superimposed on adjacent lane 40 when seen through driver door glass 72 (an example of a display medium) of vehicle 4, as illustrated in FIG. 8. In this case, highlighted images 70 and 74 can be superimposed-displayed using the foregoing head-up display technology. By naturally viewing highlighted images 70 and 74, driver 18 can more intuitively determine whether the lane change is possible.

Although both of highlighted images 70 and 74 are superimposed-displayed in this variation, the present disclosure is not limited to such, and at least one of highlighted image 70 or 74 may be superimposed-displayed. Alternatively, while superimposed-displaying at least one of highlighted image 70 or 74, for example, a front image captured by front camera 58 may be displayed on a center display (not illustrated) located in the vehicle interior of vehicle 4 and the highlighted image may be displayed in the front image in a state of being superimposed on the adjacent lane.

### (Other Variations)

While a lane change assistance device according to one or more aspects has been described above by way of the foregoing embodiment, the present disclosure is not limited to the foregoing embodiment. Other modifications obtained by applying various changes conceivable by a person skilled in the art to the foregoing embodiment and any combinations of the structural elements in different embodiments without departing from the scope of the present disclosure are also included in the scope of one or more aspects.

For example, although the display light from display 6 is reflected off area 16 of windshield 14 in the foregoing embodiment, the present disclosure is not limited to such, and the display light from display 6 may be reflected off a combiner (an example of a display medium).

Although display 6 is a head-up display in the foregoing embodiment, the present disclosure is not limited to such. For example, a windshield display in which windshield 14 itself is a transparent display may be used.

Each of the structural elements in the foregoing embodiment may be configured in the form of an exclusive hardware product, or may be implemented by executing a computer program suitable for the structural element. Each of the structural elements may be implemented by means of a program executing unit, such as a CPU and a processor, reading and executing the computer program recorded on a non-transitory recording medium such as a hard disk or semiconductor memory.

Part or all of the functions of lane change assistance device 8 according to the foregoing embodiment may be implemented by a processor such as a CPU executing a computer program.

Part or all of the structural elements constituting each device may be configured as an IC card detachably mountable to the device or a standalone module. The IC card or the module is a computer system including a microprocessor, ROM, RAM, and so forth. The IC card or the module may include super-multifunctional LSI. The IC card or the module achieves its functions by the microprocessor operating according to a computer program. The IC card or the module may be tamper-resistant.

The present disclosure may be the lane change assistance method according to the sixth aspect described above. The present disclosure may be a computer program that implements the lane change assistance method by a computer, or may be digital signals including the computer program. The present disclosure may be the computer program or the digital signals recorded in a non-transitory computer-readable recording medium, such as flexible disk, hard disk, CD-ROM, MO, DVD, DVD-ROM, DVD-RAM, Blu-ray (registered trademark) disc (BD), or semiconductor memory. The present disclosure may also be the digital signals recorded in such a recording medium. The present disclosure may be the computer program or the digital signals transmitted over a network such as an electric communication line, a wireless or wired communication line, or the Internet, data broadcasting, or the like. The present disclosure may be a computer system including a microprocessor and memory, where the memory stores the computer program and the microprocessor operates according to the computer program. The present disclosure may also be carried out by another independent computer system, by the computer program or the digital signals being recorded in the recording medium and transferred, or by the computer program or the digital signals being transferred over the network or the like.

While the embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2023-051374 filed on Mar. 28, 2023.

### INDUSTRIAL APPLICABILITY

The present disclosure is applicable to, for example, a lane change assistance device that assists a vehicle to make a lane change to an adjacent lane.

1. A lane change assistance device that assists a vehicle to make a lane change to an adjacent lane, the lane change assistance device comprising:
a lane change need determiner that determines whether there is a situation that requires the vehicle to make the lane change to the adjacent lane, based on surrounding environment information indicating a surrounding environment of the vehicle or operation information indicating that a direction indicator of the vehicle has been operated by a driver;
a lane changeability determiner that determines whether it is possible for the vehicle to make the lane change to the adjacent lane, by detecting any other vehicle traveling in the adjacent lane based on the surrounding environment information; and
a display controller that causes, when the lane change need determiner determines that there is the situation that requires the vehicle to make the lane change to the adjacent lane, a display to display an image indicating whether it is possible for the vehicle to make the lane change to the adjacent lane in a state in which the image is superimposed on the adjacent lane when seen through a display medium of the vehicle, based on a determination result of the lane changeability determiner.

2. The lane change assistance device according to claim 1,
wherein the lane changeability determiner calculates a degree of margin for the vehicle to make the lane change to the adjacent lane and, based on the degree of margin, determines, in levels, whether it is possible for the vehicle to make the lane change to the adjacent lane.

3. The lane change assistance device according to claim 2,
wherein the display controller varies a display mode of the image depending on the degree of margin.

4. The lane change assistance device according to claim 1,
wherein the display projects light representing the image to the display medium and causes the light to reflect off the display medium, to display the image as a virtual image through the display medium.

5. The lane change assistance device according to claim 4,
wherein the display medium is at least one of a windshield or a door glass of the vehicle.

6. A lane change assistance method of assisting a vehicle to make a lane change to an adjacent lane, the lane change assistance method comprising:
(a) determining whether there is a situation that requires the vehicle to make the lane change to the adjacent lane, based on surrounding environment information indicating a surrounding environment of the vehicle or operation information indicating that a direction indicator of the vehicle has been operated by a driver;
(b) determining whether it is possible for the vehicle to make the lane change to the adjacent lane, by detecting any other vehicle traveling in the adjacent lane based on the surrounding environment information; and
(c) causing, when it is determined in (a) that there is the situation that requires the vehicle to make the lane change to the adjacent lane, a display to display an image indicating whether it is possible for the vehicle to make the lane change to the adjacent lane in a state in which the image is superimposed on the adjacent lane when seen through a display medium of the vehicle, based on a determination result of (b).
